(19) United States
(12) Patent Application Publication
(10) Pub. No.: US 2013/0328431 A1
(43) Pub. Date: Dec. 12, 2013

(54) CYLINDRICAL ELECTROMAGNETIC ACTUATOR

(71) Applicants: Tat Joo Teo, Singapore (SG); Guilin Yang, Singapore (SG)

(72) Inventors: Tat Joo Teo, Singapore (SG); Guilin Yang, Singapore (SG)

(73) Assignee: Agency for Science, Technology and Research, Singapore (SG)

(21) Appl. No.: 13/990,219

(22) PCT Filed: Nov. 29, 2010
(86) PCT No.: PCT/SG2010/000445

§ 371 Date: Aug. 26, 2013

(51) Int. Cl. H02K 1/06

(52) U.S. Cl. CPC H02K 1/06
USPC 310/154.02

(57) ABSTRACT

A cylindrical-shape electromagnetic actuator comprising a plurality of pairs of magnets, the magnets of each pair being held at a distance from each other with an effective air gap formed therebetween for accommodating a coil structure; and a substantially cylindrical frame structure for supporting the pairs of magnets, the frame structure being configured such that substantially separate closed loop magnetic paths are provided for the respective pairs of magnets.

### FIELD OF INVENTION

Embodiments broadly relate to cylindrical-shape electromagnetic actuators, and, more particularly, to cylindrical Lorentz-force actuators.

### BACKGROUND

Electromagnetic (EM) actuation has recently became a promising contender in the area of ultra-high precision manipulation. One type of EM technique used to realise ultra-high precision manipulation is Lorentz-force actuation. Lorentz-force actuation is a direct non-commutation drive, which provides a constant output force with infinite positioning resolution throughout an entire travelling range without any complex control algorithm or system.

The working principle of Lorentz-force actuation is typically found in a voice-coil actuator where an effective air gap is usually formed between a housing and a permanent magnet (PM). A current may flow through a coil that operates within a magnetic flux density of the effective air gap. An introduction of current perpendicular to the magnetic flux direction generates a force that propels a moving member with the coil. The magnetic flux density within the effective air gap emanates from the PM. Some of the limitations of Lorentz force actuation are small output force and poor force-to-size ratio. To increase the generated force and to enhance the current force sensitivity of a Lorentz-force actuator, increasing the magnetic flux density within the effective air gap may be effective.

One approach increases the size of the PM. The use of a larger PM with a modified magnetic circuit design increases magnetic flux density. Magnetic circuits that use larger PMs with modified circuit design offer small effective air gaps since the magnetic flux density varies with respect to the distance from the magnet-polarised surface. Unfortunately, only small amounts of coil may operate within such small gaps. The force generated from these circuits is still limited even though the magnetic flux density has been increased through large PMs. In addition, stators of those circuits have closed-loop design on one end and open-loop design on the other to allow the moving member to move. However, such an open-loop design causes magnetic flux leakages. As a result, the magnitude of the magnetic flux density will be higher within the air gap region near the closed-loop end while lower at the region near the open-loop end. Such non-uniformity of magnetic field affects the linearity of the output force.

Another approach uses a multi-coil/multi-magnet arrangement. The multi-coil/multi-magnet arrangement uses multiple magnets to form multiple flux loops within the effective air gap. A pair of coils operates within each flux loop to drive the moving member through 2-phase commutation technique. The multi-coil/multi-magnet arrangement requires small effective air gaps for the magnetic flux to propagate from one PM to the other. Only small amounts of coil are permitted within such gaps and thus limited force can be generated from this magnetic circuit arrangement. In addition, this arrangement involves a multiple-phase commutation technique to drive the moving member via the moving coil, which is conflicting to the characteristics of Lorentz-force actuation, i.e., a single phase and non-commutation EM driving scheme.

Yet another approach uses an interleaved magnetic circuit. The interleaved magnetic circuit approach uses a principle similar to the multi-coil/multi-magnet arrangement. However, the interleaved magnetic circuit has another set of magnets, which are prearranged in a symmetrical and opposite pole arrangement, to further increase the magnitude of the magnetic flux. The interleaved magnetic circuit is designed to provide bi-directional actuation as compared to the multi-coil/multi-magnet arrangement, which actuates in one direction. The interleaved magnetic circuit approach faces issues similar to the multi-coil/multi-magnet arrangement approach. Although larger air gap and more uniform magnetic flux can be obtained from the symmetrical PM array arrangement, the interleaved magnetic circuit approach still requires multiple-phase commutation technique.

In summary, a need exists to provide a magnetic circuit design which can offer large effective air gap with high and evenly distributed magnetic flux density, in order to enhance the current-force sensitivity of a Lorentz-force actuator, and to increase the generated force.

### SUMMARY

In accordance with a first aspect of the present invention, there is provided a cylindrical-shape electromagnetic actuator comprising a plurality of pairs of magnets, the magnets of each pair being held at a distance from each other with an effective air gap formed therebetween for accommodating a coil structure; and a substantially cylindrical frame structure for supporting the pairs of magnets, the frame structure being configured such that substantially separate closed loop magnetic paths are provided for the respective pairs of magnets.

Said pairs of magnets may be configured in a mutually attracting orientation.

Said closed loop magnetic paths may be formed by a ferrous material of the frame structure.

Said closed loop magnetic paths may comprise magnet elements of side portions of said frame structure.

The actuator may further comprise an air-core coil disposed within said effective air gaps between said pairs of magnets.

Said moving air-core coil may be connected to at least one flexure-based bearing to form a nanopositioning actuator.

The actuator may comprise the flexure-based bearing connected to the frame structure.

The flexure-based bearing may be connected between a periphery of the frame structure, and one or more shafts coupled to the moving air coil.

The flexure-based bearing may comprises a disk having cut-outs therein for defining one or more meandering flexure arms.

Each flexure arm may be connected between the periphery of the frame structure and one of the shafts.

Said moving air-core coil may be connected to a rotary motor to form a two degree of freedom actuator that offers an independent translational motion and an independent rotational motion.

The rotary motor may be connected to the moving air coil via the one or more linear shafts.

A rotary shaft of the rotary motor may be supported by a rotary bearing hub, which in turn is connected to the linear shafts.

The frame structure may be configured such that the substantially separate closed loop magnetic paths for the respective pairs of magnets are defined by cut-outs.

The frame structure may comprise segments connected together to form the frame structure, each segment configured for providing a closed loop magnetic path for one of the pairs of magnets.

The frame structure may further comprise a ring element disposed on each side, for holding the segments together.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1a illustrates a dual-magnet (DM) configuration that offers a large effective air gap with high and evenly distributed magnetic flux density.

FIG. 1b illustrates a DM configuration and corresponding magnetic flux density analysis.

FIG. 1c illustrates a magnetic circuit with a single magnet, and a magnetic flux density chart measured from an effective air gap, for the single magnet magnetic circuit.

FIG. 2 illustrates a stator for a Lorentz-force actuator, according to an embodiment.

FIG. 3 illustrates a segment of the stator with DM configuration, according to an embodiment.

FIG. 4 illustrates a cross-sectional view of the segment, according to an embodiment.

FIG. 5 illustrates a schematic diagram of a DM configuration with side PMs, according to another embodiment.

FIG. 6 illustrates a view of a segment with a DM configuration including side PMs, according to the embodiment of FIG. 5.

FIG. 7 illustrates a closed-loop magnetic path of the DM configuration with side PMs, according to an embodiment.

FIG. 8 illustrates a DM-configured cylindrical-shape stator with a moving air-core coil, according to an embodiment.

FIG. 9 illustrates a nanopositioning actuator with flexure-based bearings to support the moving air-core coil, according to an embodiment.

FIG. 10 illustrates a rotary motor connected to the moving air-core coil within the DM-configured cylindrical-shape stator to form a linear-rotary actuator, according to an embodiment.

### DETAILED DESCRIPTION

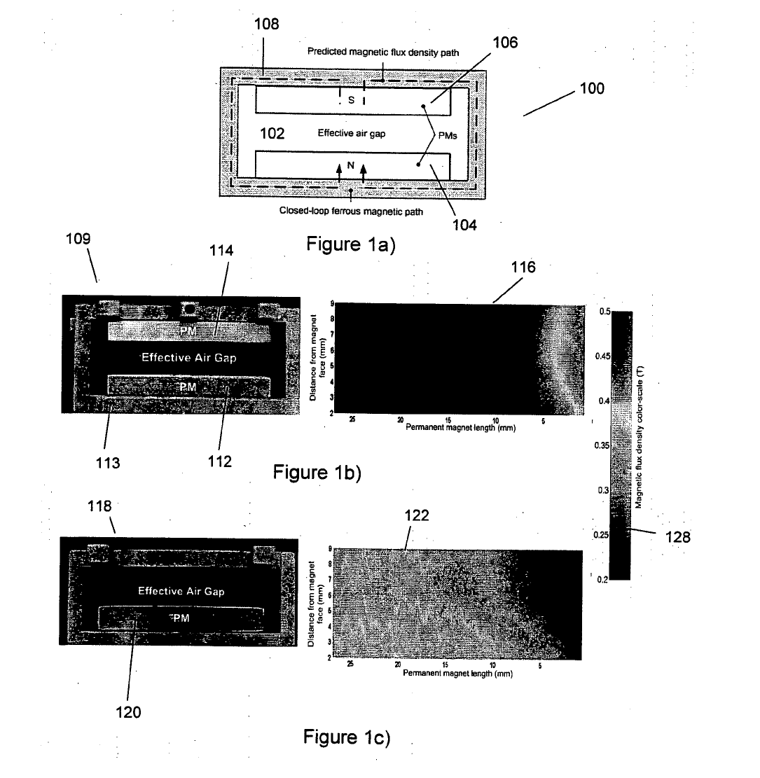

FIG. 1a illustrates a schematic cross-section of a dual-magnet (DM) configuration 100 that offers a large effective air gap 102 with high and evenly distributed magnetic flux density. This cross-section of a DM configuration is illustrated in FIG. 1a whereby two permanent magnets (PMs) 104, 106, with a common magnetic path, which includes a closed-loop ferrous magnetic path 108, are placed substantially “facing each other” in a magnetically attracting position. Two PMs are “facing each other” if the two PMs are held at a distance from each other such that the magnetic flux of either of the two PMs interacts with the magnetic flux of the other PM. Preferably, the two PMs are either held parallel with respect to each other, or the two PMs are held concentric with respect to each other. The PMs can be of any shape or form. The shape of each of the two PMs may substantially resemble a rectangular solid, for example. Two PMs that resemble rectangular solid shapes are facing each other if the two PMs are held parallel to each other. Alternatively, each of the two PMs may substantially resemble the shape of an arc of a circle, and the arc-shaped PMs are facing each other if the arc-shaped PMs are held concentric with respect to each other. Different embodiments comprise PMs of any shape or form, and are not limited to PMs that resemble rectangular solid shapes, and are also not limited to PMs that are arc-shaped.

The two PMs are held such that the magnetic flux of either of the two PMs interacts with the magnetic flux of the other PM. Any structure built from any suitable ferrous magnetic material may be used to structurally hold the PMs at a distance from each other, so that the two PMs are facing each other. As depicted in FIG. 1b, in one example iron pieces or some alloy containing iron can form a structure 113 that is used to hold the PMs 112, 114 at a distance from each other. The PMs are attached to the structure that holds the PMs at a distance from each other. This structure is also functional as the ferrous magnetic path 108 (FIG. 1a).

FIG. 1b illustrates a DM configuration 109 and a corresponding magnetic flux density analysis chart 116. The illustrated DM configuration 109 is an example of the schematic of FIG. 1a. As illustrated in FIG. 1b, a closed-loop ferrous magnetic path formed by the structure 113 encloses two PMs 112, 114. The corresponding magnetic flux density analysis chart 116 shows experimental results of the magnetic flux density sampled at different distances throughout an effective air gap 102 (FIG. 1a) of the DM configuration 109, at different points along the lengths of PM 112, 114. The magnetic flux density scale 128, in conjunction with the magnetic flux density chart 116, shows that the DM configuration 109 advantageously allows for an evenly distributed magnetic field within the effective air gap of the DM configuration 109.

Advantageously, the DM configuration can provide large and constant magnetic flux density throughout an effective air gap distance of about 11 mm, in this example. Advantageously, a higher magnetic flux and more evenly distributed magnetic field is obtained within the effective air gap of the DM configuration (compare FIG. 1c described below). Sampling of the magnetic flux density shows that the magnetic flux density is registered at about 0.5 T substantially throughout the effective air gap of the DM configuration, and the magnetic flux leakage is substantially minimal. Magnetic flux leakage is substantially restricted to the edge of the PMs. In FIGS. 1b and c, the PMs lengths (from right to left) were about 54 mm, thus the magnetic density charts 116, 122 extend from one edge of the PMs to the middle, with a symmetric configuration.

FIG. 1c illustrates a magnetic circuit 118 with a single magnet 120, and a magnetic flux density chart 122 measured from an effective air gap. The magnetic flux density chart 122 shows the magnetic flux density within the effective air gap, sampled at different distances from a face of single magnet 120, at different points along the length of single magnet 120. The magnetic flux density scale 128, in conjunction with the magnetic flux density charts 116, 122, show that the single magnet magnetic circuit 118 has poor distribution of magnetic field within the effective air gap, when compared to the evenly distributed magnetic field for the DM configuration 109 (FIG. 1c).

The poor distribution of magnetic field for the single magnet magnetic circuit 118 is due to the large amount of magnetic flux leakage in the effective air gap of the single magnet magnetic circuit 118. Such leakages of the single magnet magnetic circuit become worse as the air gap height increases. In contrast, advantageously, the magnetic flux density of the dual magnet configuration 109 (FIG. 1b) is substantially uniform throughout the effective air gap of the dual magnet configuration, and the magnetic flux leakage is minimal, the magnetic flux leakage being restricted to the edge of the PMs.

With the dual magnet configuration, the magnetic flux that emanates from the two magnets substantially amalgamates at the mid-section of the effective air gap formed between the two magnets. Advantageously, common flux leakage from both ends of the magnet is substantially minimized by the closed-loop ferrous magnetic path 108 (FIG. 1a). Hence, advantageously, a more uniform distribution of magnetic flux density can be attained within the effective air gap from such a configuration. In addition, the common magnetic path advantageously provides a high permeability closed-loop route for the magnetic flux that further amplifies the magnetic flux density within the effective air gap.

Although FIG. 1a, FIG. 1b and FIG. 1c depict the enclosing ferrous magnetic path as a substantially rectangular solid, the disclosure of electromagnetic characteristics discussed herein for the substantially rectangular solid shape, including the magnetic flux density characteristics, also apply equally to cylindrical-shape DM configurations. In other words, FIG. 1, FIG. 1b and FIG. 1c also illustrate the characteristics of electromagnetic phenomena for a cylindrical-shape DM configuration.

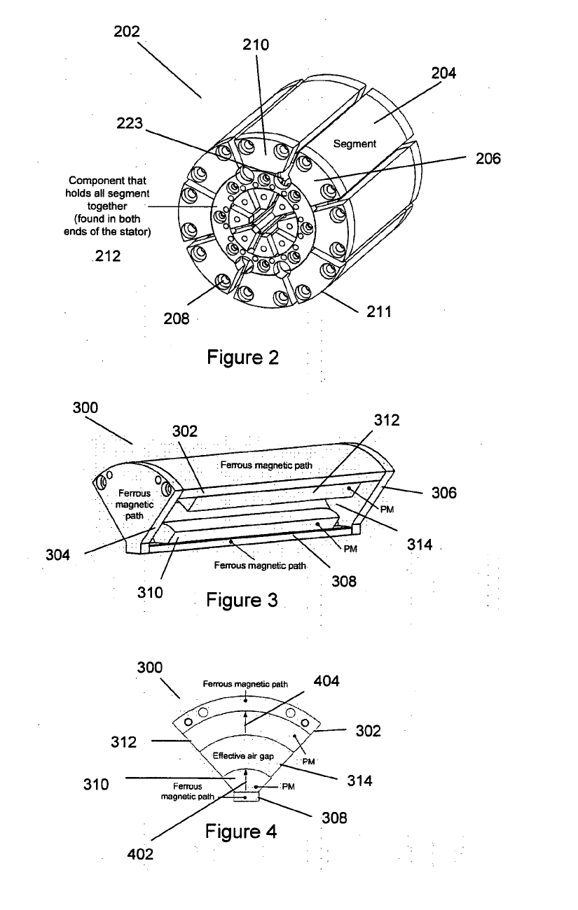

FIG. 2 illustrates a stator 202 for a Lorentz-force actuator, according to an embodiment. In the example embodiment depicted in FIG. 2, a DM-configured, substantially cylindrical-shape stator 202 comprises segments e.g. 204, where each segment includes the DM configuration and is enclosed by a common ferrous magnetic-path. The DM-configured cylindrical-shape stator 202 has a frame structure 211 comprising respective frame elements e.g. 206 of the respective segments e.g. 204 each formed with a DM configuration 100 (FIG. 1a). The frame structure 211 also includes, on both sides of the stator 202, a ring element e.g. 212 for holding the frame elements e.g. 206 together, and thus the segments e.g. 204 forming the stator 202. The various components are fixed together using screws (not shown) in this example embodiment, received in respective screw depressions and holes e.g. 208. Some of the adjacent frame elements e.g. 206, 210, form circular openings, e.g. 223, to allow a shaft to pass therethrough.

FIG. 3 illustrates a single segment 300 of a cylindrical-shape stator, according to an embodiment. The segment depicted in FIG. 3 can be representative of, for example, segment 204 of FIG. 2, albeit with a different angular spread for a four segment embodiment. As depicted in FIG. 3, segment 300 includes an enclosed common magnetic path, which is ferrous magnetic paths 302, 304, 306, and 308. Ferrous magnetic paths 302, 304, 306, and 308 are in a structure that forms the enclosure of the segment. The structure can be made of any ferrous magnetic material. Each pair of PMs 310, 312 is configured substantially facing each other in a mutually attracting orientation to allow the magnetic flux to flow from one PM 310 to the other PM 312 within the effective air gap 314. Hence, the orientation of poles of each pair of PMs preferably is in the same direction

FIG. 4 illustrates a cross-sectional view of the segment 300 (FIG. 3), according to an embodiment. As depicted in FIG. 4, segment 204 comprises ferrous magnetic paths 302, 308, PMs 310, 312, and effective air gap 314. Arrows 402, 404 depicted in FIG. 4 indicate that poles of PM 310 and PM 312 are oriented in a same direction. In some embodiments, the size and thickness of each pair of PMs need not be the same.

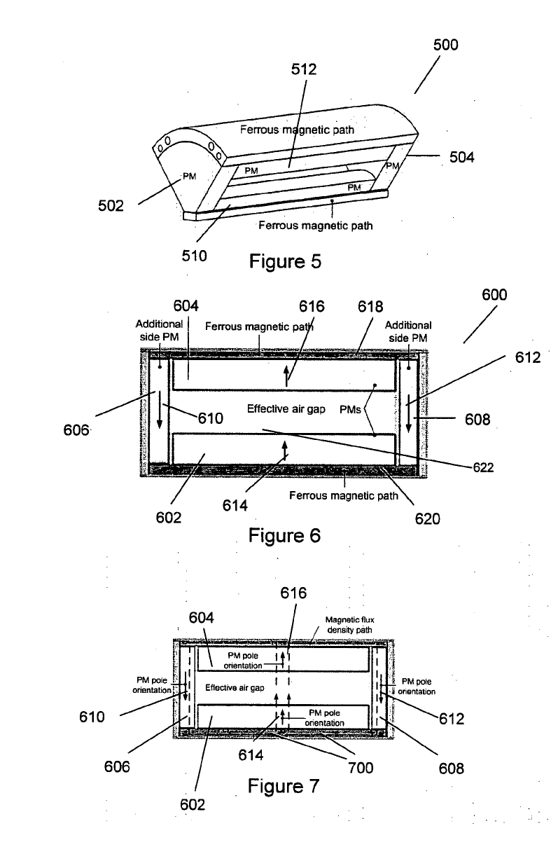

FIG. 5 illustrates a view of a segment 500 of a stator with a DM configuration, including side PMs, according to another embodiment. Side PMs 502, 504 and ferrous magnetic paths 506, 508 form an enclosure and allow for a closed-loop magnetic flux density path. The additional side PMs 502, 504 advantageously enhance the closed-loop magnetic path of the DM configuration. PMs 510 and 512 are substantially mutually aligned such that PM 510 is magnetically attracted to PM 512, and PM 512 is magnetically attracted to PM 510. The pole orientation of the side PMs 502, 504 are opposite to the pole orientation of PMs 510, 512, to preferably ensure that a closed-loop magnetic flux density path can be formed.

FIG. 6 illustrates a schematic diagram representing the DM configuration 600 with side PMs. The ferrous magnetic paths at both ends of a PM-pair 602, 604 are formed by additional PMs 606, 608, as depicted in FIG. 6. Thus, a structure embodying DM configuration 600 comprises ferrous magnetic structural parts for the ferrous magnetic paths 618, 620, and PMs 606, 608 for the side ends of the structure.

As a PM has much lower magnetic resistance when compared to the ferrous materials of the ferrous magnetic paths, these additional side PMs 606, 608 contribute to enhancing the closed-loop magnetic path (also referred to as the “magnetic flux density path” or the “closed-loop path”) of the DM configuration 600. The pole orientation 610, 612 of the side PMs 606, 608 are preferably opposite that of the pole orientations 614, 616 of PMs 602, 604. Hence, the magnetic flux density can flow substantially more efficiently within the designated closed-loop magnetic path. The closed-loop magnetic path allows magnetic flux to flow from one of the PM to the other PM. Magnetic flux flows from PM 604 to PM 602 within the effective air gap 622.

FIG. 7 illustrates a closed-loop magnetic path, which is also referred to as a “magnetic flux density path”, of the DM configuration with side PMs, according to the embodiment of FIG. 6. The pole orientation 610, 612 of the side PMs 606, 608 is opposite of the pole orientation 614, 616 of the PM-pair 602, 604, to preferably ensure that a closed-loop magnetic flux density path 702 can be formed.

Although FIG. 5 and FIG. 6 depict the closed-loop magnetic path as resembling a substantially rectangular solid shape, the disclosure of electromagnetic characteristics discussed herein for the substantially rectangular solid shape, including the magnetic flux density characteristics, apply equally to cylindrical-shape DM configurations. In other words, FIG. 5 and FIG. 6 also illustrate the characteristics of electromagnetic phenomena for a cylindrical-shape DM configuration.

FIG. 8 illustrates a Lorentz-force actuator 803 with a moving air-core coil 802 within a DM-configured substantially cylindrical-shape stator 804, according to an embodiment. For illustrative purposes, the DM-configured cylindrical-shape stator 804 illustrated in FIG. 8 is depicted with a segment removed to show the moving air-core coil 802 within the DM-configured cylindrical-shape stator 804. The DM-configured cylindrical-shape stator 804 includes a substantially cylindrical frame structure 805 for supporting pairs of magnets. The substantially cylindrical frame structure 805 is preferably formed from a ferrous material. In some embodiments, side end portions of the substantially cylindrical frame structure 805 may be replaced with magnet elements.

The DM-configured cylindrical-shape stator 804 that contains the moving air-core coil 802, as depicted in FIG. 8, may be formed with segments as described with reference to FIG. 5. Each segment may contain a pair of magnets, and the substantially cylindrical frame structure is preferably configured such that substantially separate closed loop magnetic paths are provided for the respective pairs of magnets. Each pair of magnets is preferably configured in a mutually attracting orientation. The closed loop magnetic paths are formed by the ferrous material of the frame structure. In some embodiments, the closed loop magnetic paths may also be formed by magnet elements of side end portions of the substantially cylindrical frame structure.). The frame 803 includes a cylindrical disk 812 on one side, and a cylindrical disk 814 on the other side. Each cylindrical disk 812, 814 includes cutouts, such as cutouts 816, 818 depicted on cylindrical disk 812 in FIG. 8. Each of the cutouts includes a circular opening, e.g. 823, to allow a shaft 810 to pass therethrough. In different embodiments, frame 803 can be formed by connecting together segments that are separately formed (compare e.g. FIG. 2). It is noted that the number of shafts 810 may vary (i.e. one or more) between different embodiments.

As depicted in FIG. 8, moving air-core coil 802 within a DM-configured cylindrical-shape stator 804 operates within the effective air gap of the DM-configured cylindrical-shape stator 804. The moving air-core coil 802 is formed by a conducting coil 806 wound around a cylindrical-shape bobbin 808. In this embodiment, the bobbin 808, and thus the moving air-coil 802, is supported on a central axis 807 via a linear bearing arrangement. The moving air-core coil 802 is the actuating member of the Lorentz-force actuator 803, and can drive any object with a translational motion via connecting shafts 810. For example, external linear ball bearings (not shown) can be used with the Lorentz-force actuator 803 to drive any object.

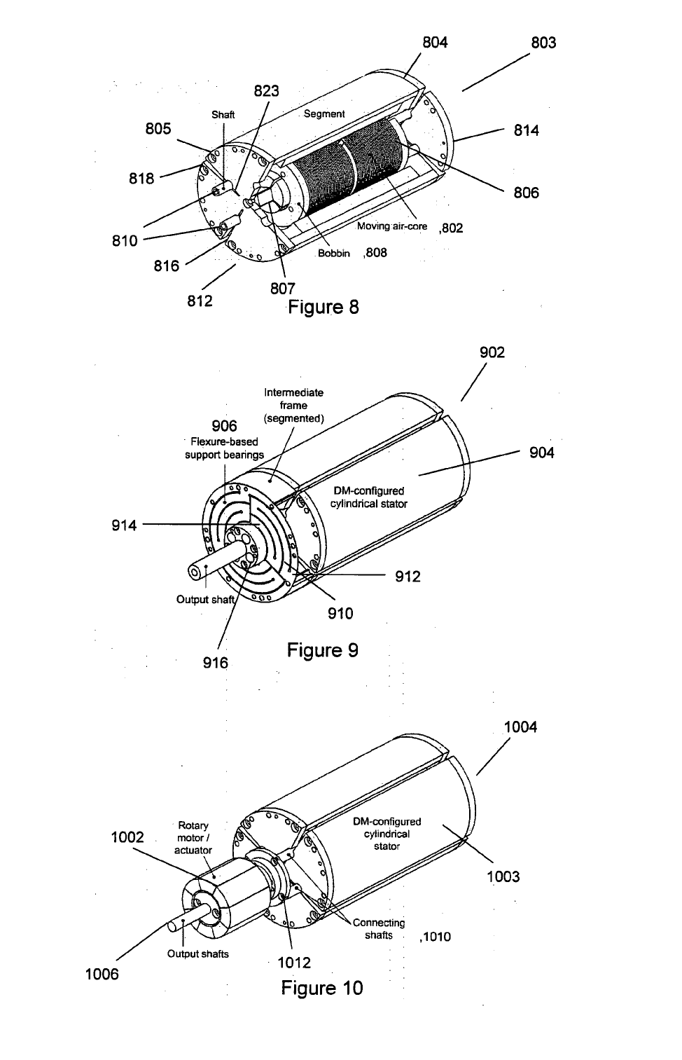

FIG. 9 illustrates a nanopositioning actuator 902 with integrated flexure-based linear bearing to support the moving air-core coil (hidden in FIG. 9, compare 802 in FIG. 8), according to an embodiment. In FIG. 9, the moving air-core coil is operating within the illustrated DM-configured cylindrical-shape stator 904. The connecting shafts (hidden in FIG. 9, compare 810 in FIG. 9) 810 are supported by a flexure-based bearing 906 to form the nanopositioning actuator 902, as depicted in FIG. 9. In the nanopositioning actuator 902, a central portion of the flexure-based bearing 906 is connected to the moving air-core coil via the connecting shafts, while the periphery of the flexure-based bearing 906 is fixed to the DM-configured cylindrical-shape stator 904 via an intermediate frame 908. This arrangement advantageously allows the flexure-based bearing 906 to provide a substantially frictionless support to the moving air-core coil. Consequently, substantially infinite positioning resolution and high repeatable motion can advantageously be achieved through the substantial elimination of friction. In this embodiment, the flexure-based bearing 906 comprises a disc-shape body with concentric cut-outs, in four segments corresponding to the segments of the stator 904 segments. As depicted in FIG. 9, the concentric cut-outs define respective meandering flexure arms e.g. 910 between respective contact portions e.g. 912 at the periphery of the flexure-based bearing 906, and contact portions e.g. 914 at a central hub 916 of the flexure-based bearing 906. However, it will be appreciated that the integrated flexure-based bearing is not limited to the specific configuration depicted in FIG. 9, but may take other suitable forms in different embodiments.

FIG. 10 illustrates a rotary motor 1002 connected to the moving air-core coil (hidden in FIG. 10, compare 802 in FIG. 8) within a DM-configured cylindrical-shape stator 1003 to form a linear-rotary actuator 1004, according to an embodiment. The moving air-core, which provides a translational motion, can be used to drive the rotary motor 1002. By connecting the moving air-core coil with the rotary motor 1002 via the connecting shafts 1010, such an arrangement forms a linear-rotary actuator 1004 that provides a translation motion and a rotation motion. More particular, the moving air-core coil is connected to the rotary motor 1002 to form the two degree of freedom (2-DOF) actuator 1004 that offers an independent translational motion and an independent rotation motion. In this embodiment, the connecting shafts 1010 are connected to a rotary bearing housing 1012, which in turn supports the output shaft 1006 of the rotary motor 1002. It will be appreciated that external supports (not shown), including linear and or rotary bearings, may be provided to configure the linear-rotary actuator 1004 for moving any object coupled to the output shaft 1006 for 2-DOF motion of the object.

In another embodiment, the rotary motor 1002 may be connected to the linear actuator 904 (FIG. 9) to form a linear rotary actuator. For example, the rotary bearing housing 1012 may be connected to the central portion of the flexure-based bearing 906 (FIG. 9).

Although permanent magnets are preferably used to form the dual magnet configuration of the example embodiments described, in different embodiments, at least one electromagnet may be used to form the dual magnet configuration.

Through the DM configuration in example embodiments, the magnetic flux density within the effective air gap can increase by about 40% as compared to magnetic circuits without the DM configuration, in one example. Such an increase in the magnetic flux density enhances the current-force sensitivity of a Lorentz-force actuator. In addition, the DM configuration allows a large effective air gap, which other magnetic circuits without the DM configuration have failed to achieve. Hence, more amounts of coil can operate within the air gap, further enhancing the current-force sensitivity. With a closed-loop magnetic path arrangement, the magnetic flux leakage can be reduced and an evenly distributed magnetic field can be achieved within the effective air gap. With an evenly distributed magnetic field, the linear characteristic of the Lorentz-force actuation is substantially ensured when the moving air-core coil operates at any location of the effective air gap. Furthermore, the DM configuration can enhance the current-force sensitivity of a Lorentz-force actuator without sacrificing the linear, single-phase, and non-commutation characteristics of a Lorentz-force actuator.

The DM configuration of example embodiments can enhance the current-force sensitivity of Lorentz-force actuators, which are commonly used for sub-micron manipulations, wire-bonding applications in semiconductor industry, and anti-vibration applications etc. The nanopositioning actuator can have a variety of industrial applications ranging from micro/nano manufacturing to bio-medical engineering, e.g. alignment stages for nano-imprinting lithography, photonics components positioning and alignment systems, MEMS components handling and assembly systems, Micro/Nano-machining systems, multi-dimensional nano-metrology systems, microsurgery, and bio-genetic research systems etc. The 2-DOF linear-rotary actuator can be employed in various applications in Surface-Mounting Technology (SMT) such as component placement operation, adhesive dispensing operation, electronic packaging, and optoelectric assembly.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

For example, while the described embodiments comprise fours DM configured segments, generally two or more DM-configured segments can be provided in different embodiments.

Also, it will be appreciated that the actuator may be implemented with a stator coil and a moving DM-configured frame structure in different embodiments.

Iron or mild steel may be used for the ferrous stator, copper wire may be used for the coils, stainless steel or carbon steel may be used for the flexure-bearings, and aluminium for intermediate frames, supporting components, shafts, and bobbin in example embodiments, but different materials may be used in different embodiments.

1. A cylindrical-shape electromagnetic actuator comprising:
a plurality of pairs of magnets, the magnets of each pair being held at a distance from each other with an effective air gap formed therebetween for accommodating a coil structure for translational movement of the coil structure under a Lorentz force; and
a substantially cylindrical frame structure for supporting the pairs of magnets, the frame structure being configured such that substantially separate closed loop magnetic paths are provided for the respective pairs of magnets.

2. The actuator of claim 1, wherein said pairs of magnets are configured in a mutually attracting orientation.

3. The actuator of claim 1, wherein said closed loop magnetic paths are formed by a ferrous material of the frame structure.

4. The actuator of claim 1, wherein said closed loop magnetic paths comprise magnet elements of side portions of said frame structure.

5. The actuator of claim 1, further comprising an air-core coil disposed within said effective air gaps between said pairs of magnets.

6. The actuator of claim 5, wherein said moving air-core coil is connected to at least one flexure-based bearing to form a nanopositioning actuator.

7. The actuator of claim 6, comprising the flexure-based bearing connected to the frame structure.

8. The actuator of claim 7, wherein the flexure-based bearing is connected between a periphery of the frame structure, and one or more shafts coupled to the moving air coil.

9. The actuator of claim 8, wherein the flexure-based bearing comprises a disk having cut-outs therein for defining one or more meandering flexure arms.

10. The actuator of claim 9, wherein each flexure arm is connected between the periphery of the frame structure and one of the shafts.

11. The actuator of claim 5, wherein said moving air-core coil is connected to a rotary motor to form a two degree of freedom actuator that offers an independent translational motion and an independent rotational motion.

12. The actuator of claim 11, wherein the rotary motor is connected to the moving air coil via the one or more linear shafts.

13. The actuator of claim 12, wherein a rotary shaft of the rotary motor is supported by a rotary bearing hub, which in turn is connected to the linear shafts.

14. The actuator of claim 1, wherein the frame structure is configured such that the substantially separate closed loop magnetic paths for the respective pairs of magnets are defined by cut-outs.

15. The actuator of claim 1, wherein the frame structure comprises segments connected together to form the frame structure, each segment configured for providing a closed loop magnetic path for one of the pairs of magnets.

16. The actuator as claimed in claim 15, wherein the frame structure further comprises a ring element disposed on each side, for holding the segments together.
